(19) United States
(12) Patent Application Publication
(10) Pub. No.: US 2006/0209022 A1
(43) Pub. Date: Sep. 21, 2006

(54) Electronic device and method of controlling the same

(76) Inventor: Masakazu Hosoda, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/356,485

(22) Filed: Feb. 17, 2006

(30) Foreign Application Priority Data
Mar. 18, 2005 (JP) 2005-078634

(51) Int. Cl. G09G 5/00

(52) U.S. Cl. 345/156

(57) ABSTRACT

In an electronic device and control method therefor according to the invention, a stick is used to operate a pointer controlled by an OS. A touch wheel is used not to operate the pointer displayed on an LCD panel but to perform an operation controlled by application software. For example, the touch wheel is used for page-up and page-down (also called scroll) of the window of application software that is displayed on the LCD panel, and fast forward and rewind in playing back an audio file or moving image. Further, another operation can be controlled by operating the touch wheel while pressing a function key attached to a keyboard.

### CROSS-REFERENCE TO RELATED APPLICATIONS

This application is based upon and claims the benefit of priority from prior Japanese Patent Application No. 2005-078634, filed Mar. 18, 2005, the entire contents of which are incorporated herein by reference.

### BACKGROUND OF THE INVENTION

1. Field of the Invention

One embodiment of the invention relates to an electronic device such as a personal computer having a pointing device, and a control method therefor.

2. Description of the Related Art

A keyboard has conventionally widely been used as an input device for a personal computer (PC). As an input device auxiliary to the keyboard, the PC often employs a pointing input device (pointing device) such as a mouse, track ball, touchpad, or stick type pointing device.

These pointing devices can be used to perform an operation of moving a pointer (cursor) displayed on the display screen of a display, and clicking or double-clicking to designate selection, execution, or the like.

Especially, PCs are equipped with either the stick type pointing device or touchpad more and more as a pointing device.

The stick type pointing device advantageously occupies only a small area. The touchpad advantageously exhibits high operability though the area occupied by the touchpad is large.

Recently, an increasing number of PCs employ the touchpad as a pointing device. This is because pointer operation is proportional to the moving amount of the finger and the pointer can be easily operated, and the user can easily scroll the window. When the user uses the touchpad to vertically scroll the window, he moves his finger from top to bottom (or from bottom to top) at the right end of the touchpad. After the user moves his finger up to the lower end, he moves it again to the upper right end of the touchpad, and moves it again from top to bottom as if the finger slid on the touchpad. As a result, the window is scrolled.

Another electronic device also exists which has a wheel around a track ball and enables scroll with the wheel.

It is disclosed by, for example, U.S. Pat. No. 6,788,288.

However, the area of the touchpad is limited. In order to keep scrolling an application window, the user moves his finger from top to bottom once, temporarily moves it off the touchpad, puts it to the upper end of the touchpad again, and repetitively slides from top to bottom.

In this case, the user must return his finger to the upper end after the finger slides on the touchpad many times, resulting in poor operability.

According to the technique disclosed in U.S. Pat. No. 6,788,288, a track ball and click button are arranged in a mechanical wheel. Since the wheel rotates by a mechanical structure, the wheel may degrade owing to friction or the like upon rotating the wheel. Since the wheel has a large diameter, a large area is required to mount the wheel, and it becomes difficult to mount the wheel in a compact electronic device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a plan view showing an example of a PC serving as an electronic device according to the first embodiment of the invention;

FIG. 2 is a functional block diagram showing an example of the hardware configuration of the PC serving as the electronic device according to the first embodiment;

FIG. 3 is an enlarged view showing an example of a structure around a stick on the upper surface of the main body case of the PC serving as the electronic device according to the first embodiment;

FIG. 4 is a sectional view taken along the line Z-Z in FIG. 3;

FIG. 5 is a block diagram showing an example of a software configuration which implements an electronic device control method according to the first embodiment;

FIG. 6 is a view showing an example of a utility software setting window displayed from the PC serving as the electronic device according to the first embodiment;

FIG. 7 is a view showing an example of an application software registration window for setting an operation with a touch wheel in the PC serving as the electronic device according to the first embodiment;

FIG. 8 is a flowchart showing an example of a control flow of the touch wheel when a browser application is executed in the PC serving as the electronic device according to the first embodiment; and

FIG. 9 is a flowchart showing an example of a control flow of the touch wheel when a music playback application is executed in the PC serving as the electronic device according to the first embodiment.

### DETAILED DESCRIPTION

Various embodiments according to the invention will be described hereinafter with reference to the accompanying drawings. In general, according to one embodiment of the invention, an electronic device comprises a main body having a keyboard, a display which is pivotally connected to the main body and has display means, a first pointing device which is attached to the main body and configured to operate a pointer controlled by an operating system, and a second pointing device which is configured to operate an application program that runs on the operating system.

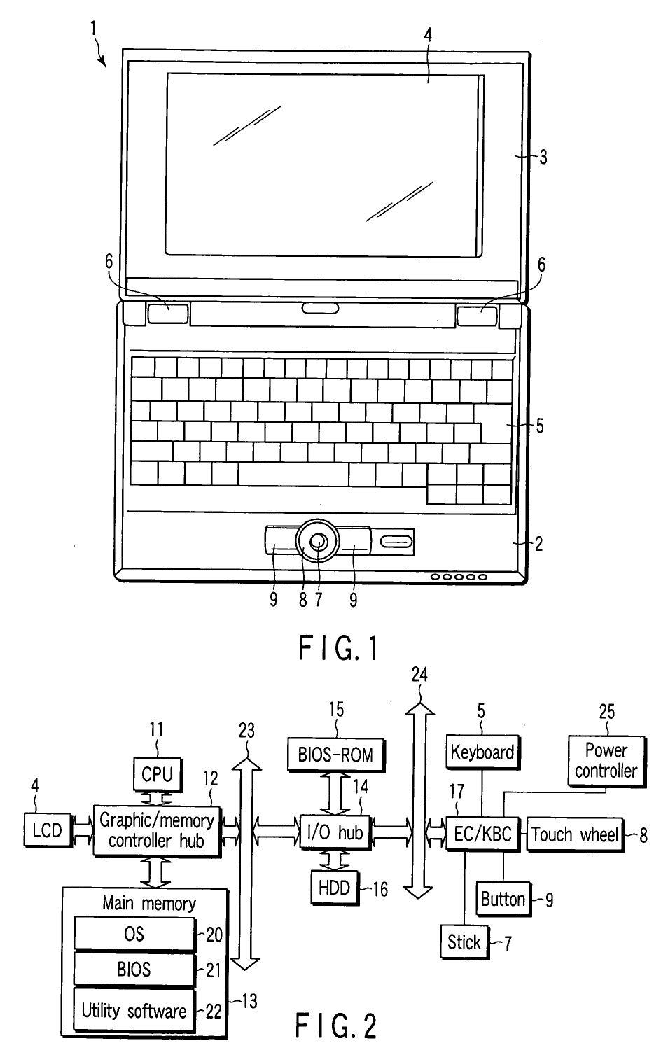

According to an embodiment, FIG. 1 is a plan view showing an example of a PC serving as an electronic device according to the first embodiment of the present invention.

A PC 1 comprises a main body case 2, display case 3, LCD panel 4, and keyboard 5. The main body case 2 has the keyboard 5 arranged on the upper surface. The main body case 2 and display case 3 are pivotally connected by hinges 6. The display case 3 holds the periphery of the LCD panel 4 so that the display area of the LCD panel 4 can be seen. A stick 7 serving as a stick type pointing device is arranged in front of the keyboard 5 on the upper surface of the main body case 2. The stick 7 is surrounded by a ring-like (doughnut-like) touch panel 8 (to be referred to as a touch wheel hereinafter). Two buttons 9 to determine an instruction to the cursor operated by the stick 7 are arranged outside the touch wheel 8.

The display case 3 can pivot via the hinges 6 between a closed position where it covers the keyboard 5 and an open position where the keyboard 5 can be used.

FIG. 2 is a functional block diagram showing an example of the hardware configuration of the PC serving as the electronic device according to the first embodiment.

As shown in FIG. 2, the PC 1 comprises a CPU 11, graphic/memory controller hub 12, main memory 13, I/O hub 14, BIOS-ROM 15, hard disk drive (HDD) 16, embedded controller/keyboard controller (EC/KBC) 17, and the like.

The CPU 11 controls the operation of the whole PC 1, and refers to data contents of the main memory 13 to execute data processing and the like on the basis of the data contents. Although not shown, the CPU 11 operates on the basis of a clock supplied from an external clock generator.

While the PC 1 runs, the main memory 13 stores an operating system (OS) 20, a partial function 21 of the BIOS-ROM 15, utility software 22, an execution application, and the like. The main memory 13 reads/writes data via the graphic/memory controller hub 12 in response to an instruction from the CPU 11.

The OS 20 comprehensively manages/controls hardware and software operations of the PC 1. The OS 20 also manages, for example, whether to give the right of processing of the CPU 11 (right to use the CPU 11) to an application procedure such as an interrupt.

The BIOS 21 is a systematic function execution routine to access various hardware devices in the PC 1. When the PC 1 starts up, the BIOS 21 is read out from the BIOS-ROM 15. The BIOS 21 holds power saving settings for power supply control and the like to various hardware devices.

The utility software 22 operates in cooperation with the BIOS 21 and OS in order to execute proper processing upon occurrence of events (interrupt and the like) from various devices.

The graphic/memory controller hub 12 is a bridge LSI which connects the CPU 11 and a first bus 23 and connects the CPU 11 and main memory 13. The graphic/memory controller hub 12 functions as one of bus master devices for the first bus 23. The graphic/memory controller hub 12 has a function of converting the bus width including data and an address between the CPU 11 and the first bus 23, and a function of controlling access to the main memory 13 via a memory bus. The graphic/memory controller hub 12 also has a display controller function, and transmits display data to the LCD panel 4 connected to the graphic/memory controller hub 12.

The I/O hub 14 is a bridge circuit which executes data conversion and the like between the graphic/memory controller hub 12 and a device on a low pin count (LPC) bus 24 connected to the I/O hub 14. The I/O hub 14 incorporates various I/O controllers.

The BIOS-ROM 15 is a program obtained by systematizing a function execution routine of accessing various hardware devices in the PC. The BIOS-ROM 15 is formed from a flash ROM so that a program can be rewritten. When the PC 1 starts up, the BIOS-ROM 15 initializes various hardware devices. Upon activation, some programs of the BIOS-ROM 15 are copied to the memory 13 to perform I/O control of various hardware devices even during execution of the OS.

The HDD 16 is a nonvolatile storage device which stores data, and can hold data even while the PC 1 is off. The HDD 16 stores an OS, various applications, drivers, utility software, and content data (e.g., music data and video data). These data are properly read into the memory 13 by the CPU 11, and the read data are further processed by the CPU 11.

The EC/KBC 17 incorporates a plurality of registers capable of read/write by the CPU 11. The registers allow the CPU 11 and a device connected to the EC/KBC 17 to communicate with each other. The EC/KBC 17 also incorporates a keyboard controller function. The EC/KBC 17 processes signals input from the keyboard 5, stick 7, and touch wheel 8 which are connected to the EC/KBC 17, and notifies a host device (e.g., the CPU 11) of the signals.

The EC/KBC 17 is further connected to a power controller 25. The power controller 25 controls the overall power supply of the PC 1, and supplies, to devices in the PC 1, power from a battery (not shown) serving as a secondary battery or power from an AC adaptor serving as an external power supply. The power controller 25 performs charge/discharge control of the battery, and monitors the remaining battery life. When power is supplied from the AC adaptor, the power controller 25 executes charge control in accordance with the remaining battery life.

The stick 7, touch wheel 8, and buttons 9 are connected to the EC/KBC 17. Upon reception of inputs from the respective input devices, the EC/KBC 17 processes the input signals, and notifies a host device of the input information.

In the embodiment, the stick 7 is used to operate a pointer controlled by the OS 20. The touch wheel 8 is used not to operate the pointer displayed on the LCD panel 4, but to perform an operation controlled by application software. For example, the touch wheel 8 is used for page-up and page-down (also called scroll) of the window of application software that is displayed on the LCD panel 4, and fast forward and rewind in playing back an audio file or moving image. In the embodiment, another operation can be controlled by operating the touch wheel 8 while pressing a function key (Fn) attached to the keyboard 5, details of which will be described.

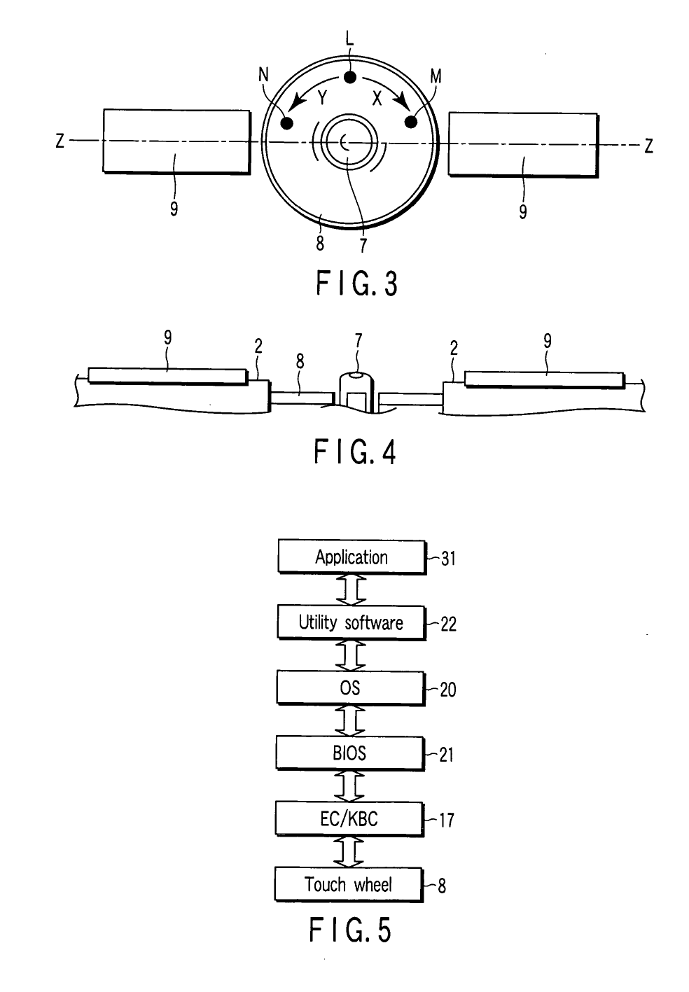

Details of the operation will be explained with reference to FIGS. 3 to 9.

FIG. 3 is an enlarged view showing an example of a structure around the stick on the upper surface of the main body case of the PC according to the first embodiment.

As shown in FIG. 3, the ring-like touch wheel 8 is arranged on the upper surface of the main body case so as to surround the stick 7. The buttons 9 are arranged outside the touch wheel 8.

The stick 7 represents the moving amount of the pointer by a vector quantity. The moving direction and moving amount of the pointer are determined in accordance with the inclination angle of the stick 7 to control movement of the pointer displayed on the LCD panel 4.

The touch wheel 8 is an input device which detects a position and moving amount by an electrostatic capacitance method. A current touch point and moving amount are determined on the basis of a change in electrostatic capacitance held by the touch wheel 8. More specifically, the touch wheel 8 has an upper surface which is touched with a finger, and a lower surface below the upper surface. The touch wheel 8 holds an electrostatic capacitance between the upper and lower surfaces. When the finger or another conductor touches the upper surface, the electrostatic capacitance changes, and the change amount is read to detect an input. For example, when the finger is put at a point L of the touch wheel 8 in FIG. 3 and moves to a point M (direction indicated by an arrow X), the moving direction and moving amount of the finger are detected to detect that the finger has moved clockwise. At the same time, the moving amount of the finger is detected, and page-down (scroll) of the window is done in accordance with the moving amount. When it is detected that the finger has moved from the point L to a point N (direction indicated by an arrow Y), it is detected that the finger has moved counterclockwise, and page-up (scroll) of the window is executed in accordance with the detected moving amount.

FIG. 4 is a sectional view taken along the line Z-Z in FIG. 3.

As shown in FIG. 4, the touch wheel 8 is arranged with a small difference in level from the main body case 2. In operation, the user moves his finger from the height of the main body case 2 in the direction of height, and can determine the position of the touch wheel 8 only by touch. In the embodiment, the height of the stick 7 can be ensured from the surface of the touch wheel 8 by recessing the touch wheel 8 in the main body case 2. The projecting amount of the stick 7 from the main body case 2 suffices to be small, which contributes to a flat structure of the PC 1.

FIG. 5 is a block diagram showing an example of a software configuration which implements an electronic device control method according to the first embodiment of the present invention.

As shown in FIG. 5, input information on the operation of the touch wheel 8 is transmitted to the OS 20 via the EC/KBC 17 and BIOS 21. When any application software runs on the OS 20, a behavior corresponding to an application 31 is executed via the utility software 22.

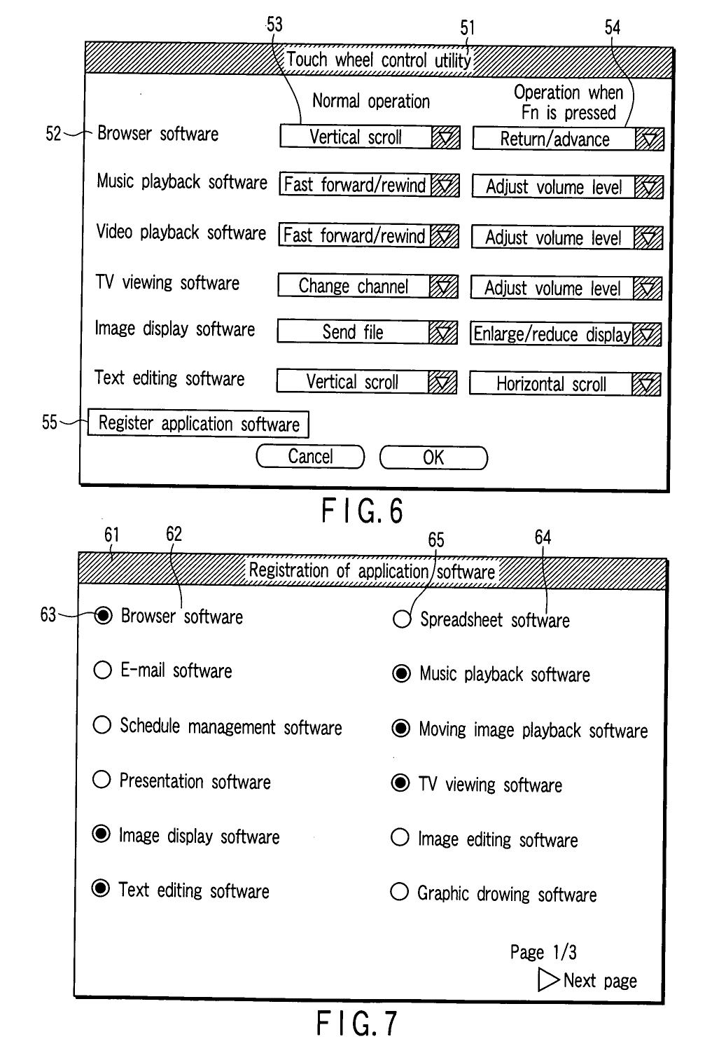

FIG. 6 is a view showing an example of a utility software setting window displayed from the PC serving as the electronic device according to the first embodiment.

FIG. 6 illustrates an example of setting each application software and a behavior (control) upon operating the touch wheel 8.

FIG. 6 shows a window 51 for a setting example of utility software which sets the operation of the touch wheel 8. The window 51 displays software names 52, and drop-down lists 53 and 54 used to set what kinds of operation and control are to be executed when the touch wheel 8 is operated. In this case, an operation upon operating the touch wheel can be set for each application software. For example, for the browser software 52, when the finger or conductor is put on the touch wheel 8 and moved in the X or Y direction in FIG. 3, the page-up/page-down (vertical scroll) 53 of a Web page displayed by the browser software 52 (or a file which can be displayed in the HTML format or by browser software) is executed. When the finger moves in, e.g., the Y direction in FIG. 3 while the function (Fn) key is pressed, a page displayed immediately before the currently displayed Internet page is displayed (return). When the finger moves in the X direction, a page displayed before the “return” operation is displayed again (advance).

In this manner, the embodiment can set an operation/control when the touch wheel 8 is operated for each application software, as shown in FIG. 6.

The user can use the touch wheel 8 to select an application for which the operation is to be set. In this case, a “register application software” button 55 in the window 51 is clicked to display a registration window shown in FIG. 7.

FIG. 7 shows an example of an application software registration window for setting an operation with the touch wheel in the PC serving as the electronic device according to the first embodiment.

A window 61 displays application software names 62 and 64. Markers 63 and 65 are displayed for the respective application software programs so as to determine whether the application software programs are selected or not.

For example, the browser software 62 serving as an application to be associated with the operation of the touch wheel 8 is selected. The marker 63 is marked with a full circle representing that the browser software 62 is selected.

The spreadsheet software 64 serving as an application which is not associated with the operation of the touch wheel 8 is not selected. Thus, no full circle is displayed at the marker 65.

Six application software programs selected in FIG. 7 are displayed as application software programs associated with the operation of the touch wheel 8 in FIG. 6.

Note that FIGS. 6 and 7 according to the embodiment show the type of application software. Alternatively, the name of a specific application can be displayed to set each application.

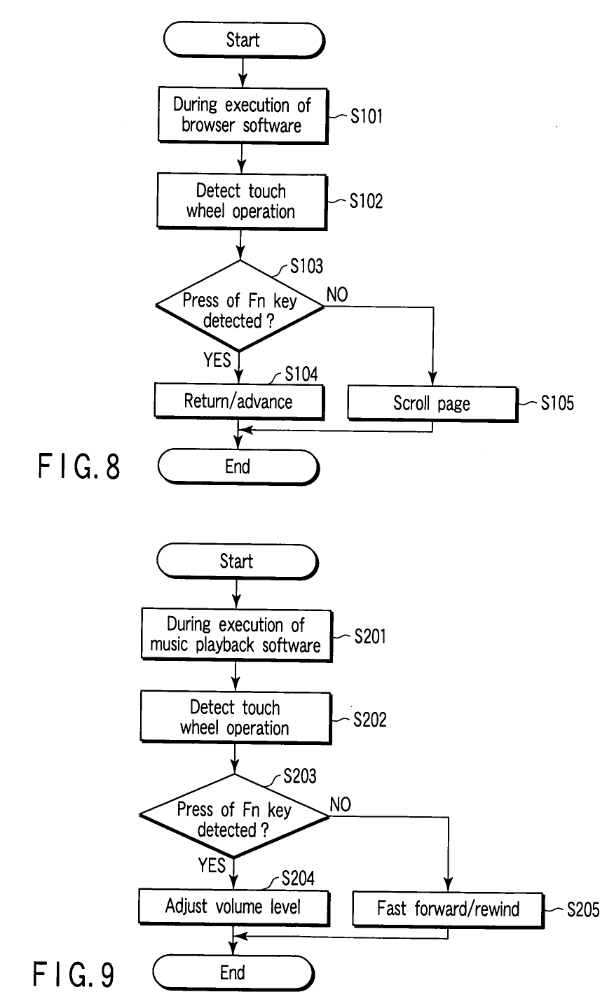

FIG. 8 is a flowchart showing an example of control of the touch wheel when a browser application is executed according to the first embodiment.

The browser application starts in the PC 1 to execute Web browsing (step S101).

If the operation of the touch wheel 8 is detected during browsing (step S102), it is determined whether the function key (Fn) has been pressed (step S103). If it is determined that the Fn key has been pressed (YES in step S103), an operation set for the operation upon pressing the Fn key is executed, as shown in FIG. 5 (step S104). In this case, display control of a Web location displayed by the browser software is done. For example, when the finger moves in the Y direction in FIG. 3, a page displayed immediately before the currently displayed Web location is displayed (return). When the finger moves in the X direction, a page displayed before the “return” operation is displayed again (advance).

If it is determined in step S103 that the Fn key is not pressed (NO in step S103), an operation set for normal operation described in FIG. 5 is performed (step S105). In this example, a page displayed by the browser software is scrolled vertically. For example, page-down processing is done when the finger moves in the X direction in FIG. 3, and page-up processing is performed when the finger moves in the Y direction.

FIG. 9 is a flowchart showing an example of control of the touch wheel when a music playback application is executed according to the first embodiment.

The music playback application starts to play back a music file recorded in a predetermined format (step S201).

If the operation of the touch wheel 8 is detected during playback (step S202), it is determined whether the function key (Fn) has been pressed (step S203). If it is determined that the Fn key has been pressed (YES in step S203), an operation set for the operation upon pressing the Fn key is executed, as shown in FIG. 5 (step S204). In this case, the volume level is adjusted. For example, the volume level is raised when the finger moves in the X direction in FIG. 3, and lowered when the finger moves in the Y direction.

If it is determined in step S203 that the Fn key is not pressed (NO in step S203), an operation set for normal operation described in FIG. 5 is performed (step S205). In this example, fast forward and rewind of a music playback file are executed. For example, fast forward of the music is done when the finger moves in the X direction in FIG. 3, and rewind of the music is done when the finger moves in the Y direction.

As described above, the control/operation upon operating the touch wheel 8 changes depending on application software. The same control flow also applies to another application software shown in FIG. 6.

In this manner, the present invention can provide a user-friendly electronic device by using both the stick type pointing device and touch wheel.

In the embodiment, control is performed in accordance with a touch wheel operation while the function key (Fn) is kept pressed. However, the key is not limited to the function key, and an arbitrary key such as the control key or shift key may be freely set. The embodiment has exemplified control setting of application software, but can also be applied to anther setting such as brightness control of the LCD panel.

Further, the embodiment can save the design space of the electronic device by arranging a ring-like touchpad around a stick type pointing device. This contributes to a flat, compact structure of the electronic device.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a main body having a keyboard;
a display which is pivotally connected to the main body and has display means;
a first pointing device which is attached to the main body and configured to operate a pointer controlled by an operating system; and
a second pointing device which is configured to operate an application program that runs on the operating system.

2. A device according to claim 1, wherein the first pointing device and the second pointing device are arranged on substantially the same plane as a plane of the main body on which the keyboard is arranged.

3. A device according to claim 2, wherein the first pointing device includes stick type input means, and the second pointing device includes planar input means.

4. A device according to claim 1, wherein the second pointing device has a ring shape, and the first pointing device is arranged in the ring.

5. A device according to claim 1, further comprising a predetermined key attached to the keyboard, wherein when the second pointing device is operated while the predetermined key is pressed, a second operation different from an operation of the application program can be implemented.

6. A device according to claim 1, wherein the first pointing device includes stick type input means, the second pointing device includes planar input means, and the second pointing device is arranged at a level different from a plane of a case of the main body.

7. An electronic device comprising:
a main body having a keyboard on an upper surface;
a display which is pivotally connected to the main body and has display means;
a ring-like touch panel which is arranged in front of the keyboard of the main body; and
a stick type pointing device which is arranged in the ring-like touch panel.

8. A device according to claim 7, wherein the ring-like touch panel is used for an operation of a first function of an application program which runs on an operating system under which the electronic device operates.

9. A device according to claim 7, wherein when the ring-like touch panel is operated while a predetermined key attached to the keyboard is pressed, an operation of a second function different from the first function can be implemented.

10. A method of controlling input of an electronic device having a first pointing device and a second pointing device, comprising:
controlling, in accordance with information input from the first pointing device, a pointer which is operated on an operating system under which the electronic device operates; and
performing, in accordance with information input from the second pointing device, an operation of a first function of an application program which runs on the operating system.

11. A method according to claim 10, in which the electronic device has a keyboard, and which further comprises determining whether a predetermined key attached to the keyboard has been pressed, and when the predetermined key is determined to have been pressed and an input from the second pointing device is detected, performing an operation of a second function different from the operation of the first function.
